(19) United States
(12) Patent Application Publication
(10) Pub. No.: US 2025/0126480 A1
(43) Pub. Date: Apr. 17, 2025

(54) WIRELESS GATEWAY DEVICES TRACKING

(71) Applicant: T-Mobile Innovations LLC, Overland Park, KS (US)

(72) Inventors: Imran KADER, Plano, TX (US); Venkata DWARAMPUDI, Overland Park, KS (US)

(21) Appl. No.: 18/487,455

(22) Filed: Oct. 16, 2023

(51) Int. Cl. H04W 12/64; H04W 64/00; H04W 88/16

(52) U.S. Cl. CPC H04W 12/64; H04W 64/003; H04W 88/16

(57) ABSTRACT

A method for tracking the location of wireless gateway devices (such as home internet devices) that includes collecting location coordinates for wireless gateway devices. The method additionally includes determining the location coordinates satisfy a threshold distance from a fixed location, such as a subscriber home location. The method further includes adjusting the wireless gateway device access to the wireless network based on satisfying the threshold distance from the fixed location.

### TECHNICAL BACKGROUND

A wireless network, such as a cellular network, can include an access node (e.g., base station) serving multiple wireless devices or user equipment (UE) in a geographical area covered by a radio frequency (RF) transmission provided by the access node. As technology has evolved, different carriers within the cellular network may utilize different types of radio access technologies (RATs). RATs can include, for example, 3G RATs (e.g., GSM, CDMA etc.), 4G RATs (e.g., WiMax, LTE, etc.), and 5G RATs (new radio (NR)). As access nodes have evolved, networks may include a combination of multiple access node such as 4G LTE evolved NodeBs (eNodeBs) and 5G NR next generation NodeBs (gNodeBs) or alternatively may be exclusively 4G or 5G cellular systems. Wireless devices closer to a 5G antenna are more likely to receive the benefits of the 5G technology.

The evolving capabilities of cellular systems have led to expanded use of such systems for Internet access. Thus, instead of traditional wired broadband connections, it has become possible to access the Internet through cellular technologies. These cellular technologies may utilize, for example, mobile broadband devices or fixed wireless access (FWA) devices. More recently, wireless gateway devices have become popular for home use. Such wireless gateway devices provide Internet access through the use of 4G and/or 5G networks and further provide wireless local area network (WLAN) capabilities enabling home devices to join a WLAN in order to obtain Internet access. Currently, no convenient method exists for tracking wireless gateway devices.

### OVERVIEW

One aspect of the present disclosure relates to a system configured for adjusting attachment of a wireless gateway device. The system may include one or more hardware processors configured by machine-readable instructions. The processor(s) may be configured to collect location coordinates for radio frequency telemetry data from a wireless gateway device. The processor(s) may be configured to determine from the location coordinates the wireless gateway device is outside geofencing coordinates for a fixed location associated with the wireless gateway device. The processor(s) may be configured to, based on determining from the location coordinates the wireless gateway device is outside the geofencing coordinates for the fixed location, adjust a capability of the wireless gateway device to attach to a wireless network.

In some implementations of the system, the processor(s) may be configured to determine a change in occupant for the fixed location.

In some implementations of the system, adjusting the capability of the wireless gateway device to attach to the wireless network may include preventing the wireless gateway device from attaching to the wireless network.

In some implementations of the system, adjusting the capability of the wireless gateway device to attach to the wireless network may include changing the fixed location to a new fixed location for the wireless gateway device.

In some implementations of the system, adjusting the capability of the wireless gateway device to attach to the wireless network may include changing a wireless network subscription for the wireless gateway device.

In some implementations of the system, the fixed location may be a known subscriber physical address of the wireless gateway device.

In some implementations of the system, the fixed location for the wireless gateway device may be maintained in a wireless gateway device profile.

Another aspect of the present disclosure relates to a method for adjusting attachment of a wireless gateway device. The method may include collecting location coordinates for radio frequency telemetry data from a wireless gateway device. The method may include determining from the location coordinates the wireless gateway device is outside geofencing coordinates for a fixed location associated with the wireless gateway device. The method may include, based on determining from the location coordinates the wireless gateway device is outside the geofencing coordinates for the fixed location, adjusting the capability of the wireless gateway device to attach to a wireless network.

Yet another aspect of the present disclosure relates to a non-transient computer-readable storage medium having instructions embodied thereon, the instructions being executable by one or more processors to perform a method for adjusting attachment of a wireless gateway device. The method may include collecting location coordinates for radio frequency telemetry data from a wireless gateway device. The method may include determining from the location coordinates the wireless gateway device is outside geofencing coordinates for a fixed location associated with the wireless gateway device. The method may include, based on determining from the location coordinates the wireless gateway device is outside the geofencing coordinates for the fixed location, adjusting the capability of the wireless gateway device to attach to a wireless network.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 depicts an exemplary wireless communication network, in accordance with the disclosed embodiments.

FIG. 2 depicts an exemplary wireless gateway device in accordance with disclosed embodiments.

FIG. 3 depicts an exemplary access node in accordance with disclosed embodiments.

FIG. 4 depicts an exemplary tracking system in accordance with disclosed embodiments.

FIG. 5 is a flow chart illustrating a method for tracking and adjusting wireless gateway device capability in accordance with one disclosed embodiment.

### DETAILED DESCRIPTION

Exemplary embodiments described herein include systems, methods, and computer readable mediums for tracking locations of wireless gateway devices (Wi-Fi gateways) and for adjusting capabilities of the wireless gateway devices based on location. The wireless gateway devices allow connection over a cellular network to the Internet and may also referred to as home internet (HINT) devices. These wireless gateway devices or HINTS operate effectively in areas with a strong cellular signal. By using location coordinates of radio frequency (RF) telemetry periodically provided by a wireless gateway device, embodiments provided herein establish whether a wireless gateway device has moved from its fixed location. Once movement has been established, adjustments can be made to the wireless gateway device capability to attach to a wireless network.

Wi-Fi gateways may, for example, include a router/modem combination allowing wireless devices to connect to Wi-Fi and further to connect to the Internet through the use of cellular network. The cellular network may, for example, utilize 4G LTE or 5G RATs. Other RATs may alternatively or additionally be implemented. The Wi-Fi gateways have functionality that allows them to periodically transmit RF telemetry parameters and other data to an access node. The RF telemetry parameters may include, for example, reference signal received power (RSRP), reference signal received quality (RSRQ), and signal to noise, interference ratio (SINR) and location coordinates. Additionally, the wireless gateway device may be associated with a particular technology, such as 4G or 5G. Further, in embodiments set forth herein, access node information, such as band, bandwidth, and architecture (e.g., 5G stand-alone (5GSA), 5G non-stand-alone (5GNSA)) can also be transmitted by the wireless gateway device and incorporated in a model for throughput estimation.

In particular, embodiments set forth herein include enhanced logic for tracking wireless gateway devices using location coordinates and geofencing for a fixed location. Embodiments allow a mobile network operator (MNO) to identify subscribers with a wireless gateway device that has moved from a fixed location or are using the wireless gateway device as a hotspot at different locations. Wireless gateway devices may be being used at locations other than the intended fixed location for the subscriber.

Currently, subscribers do not report to the MNO when the subscriber has moved from a fixed location (such as a home residence) to another location. Embodiments herein identify whether a movement of a wireless gateway device is a permanent move (such as moving from one home residence to another home residence) or is continuously moving and being used as a hotspot device.

Logic is used to determine change in occupancy data (such as multiple listing service (MLS) sales data) and telemetry data over time from wireless gateway devices to identify and categorize subscribers who are moving the wireless gateway device every day, moved to a different fixed location in the past and/or have moved to a fixed location recently.

In implementation, fixed locations from subscriber profiles for wireless gateway devices are determined. The fixed locations are compared to change in occupancy data (such as MLS sales data) to determine if a fixed location has changed occupants. The location coordinates for the wireless gateway devices are collected. The location coordinates for the wireless gateway device may include the most used location and most recent location from the RF telemetry data.

A combined data set using Mobile Station International Subscriber Directory Number (MSISDN) and International Mobile Equipment Identity (IMEI) is created. Using data from the combined data set, in embodiments, the distance from a fixed location and the most used location (based on the location coordinates) is determined for the wireless gateway device. The distance from a fixed location and the latest used location (based on the location coordinates) is determined for the wireless gateway device. The fixed location may be original location for the subscriber contact. In embodiments, the fixed location may be identified as having a change in occupancy (e.g., residence has been sold).

Based on the distances calculated, wireless gateway devices may be categorized. For example, if the distance of the most used location is greater than a threshold distance from the fixed location and wireless gateway device uses a threshold number of different access nodes on a regular basis (e.g., daily), the wireless gateway device is categorized as “moves every day.”

If the distance of most used and latest used locations are within a threshold distance from the fixed location, the wireless gateway device is categorized as “used where it was sold.”

If the distance of the most used location and the latest used location are greater than a threshold distance from the fixed location, the wireless gateway device is categorized as “used not at sold location.” Additional categories include “recently moved” if the most used location is near the fixed location and “most of the use is not where sold” if the latest location is near sold location but is not the most used location.

In embodiments disclosed herein, a cell or wireless network may be provided by an access node. The access node may utilize one or more antennas to communicate with wireless devices or user equipment (UEs), such as for example, wireless phones and wireless gateway devices.

An exemplary system described herein includes a tracking system, at least an access node (or base station), such as an eNodeB, or gNodeB, as well as one or more wireless gateway devices. For illustrative purposes and simplicity, the disclosed technology including tracking system will be illustrated and discussed as being implemented in the communications between an access node (e.g., a base station) and a wireless gateway device, Wi-Fi gateway device, or HINT device It is understood that the disclosed technology may also be applied to communication between an end-user wireless device and various network resources, such as relay nodes, controller nodes, antennas, etc. Further, multiple access nodes may be utilized. For example, some wireless devices may communicate with an LTE eNodeB and others may communicate with an NR gNodeB.

In addition to the systems and methods described herein, the operations for tracking wireless gateway devices may be implemented as computer-readable instructions implemented by a wireless device or network nodes such as processing nodes. The processing node may include a processor included in the access node or a processor included in any controller node in the wireless network that is coupled to the access node.

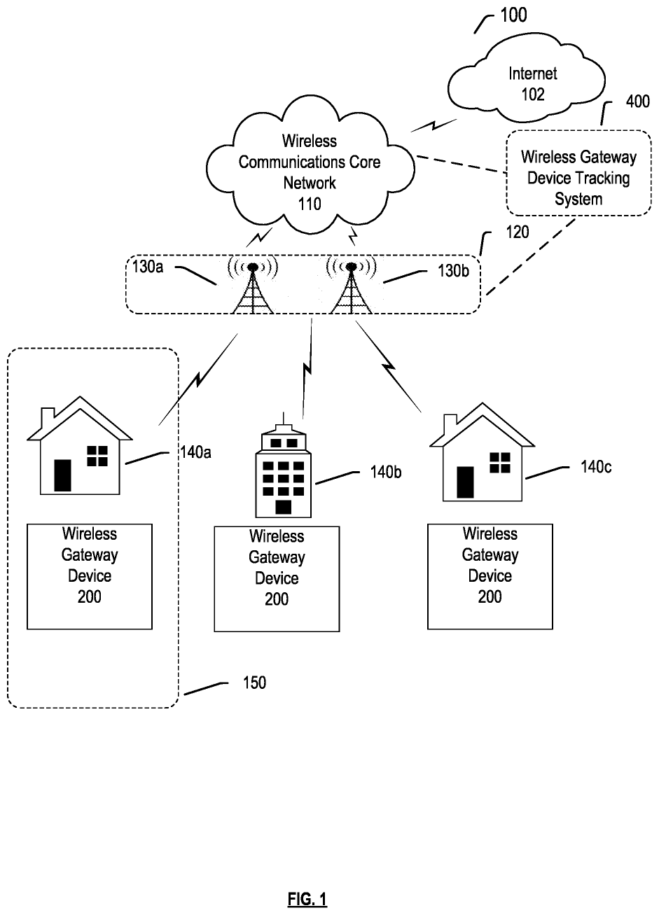

FIG. 1 depicts an exemplary communication network 100. A core network 110 is coupled to a radio access network (RAN) 120 including access nodes 130a, 130b. The core network 110 and RAN 120 serve a wireless gateway device 200 over communication links. The communication links use 5G NR, 4G LTE, or any other suitable type of radio access technology (RAT). Core network 110 can be structured as an evolved packet core (EPC) network or as a 5G core using a service-based architecture (SBA) utilizing core network functions and elements, including, for example, user plane functions (UPF) control plane functions (CPF). The core network 110 provides access to the Internet 102.

The RAN 120 can include various access network functions and devices disposed between the core network 110 and wireless gateway device 200. For example, the RAN 120 includes at least an access node (or base station), such as eNodeB and/or gNodeB 130a, 130b communicating with wireless gateway device 200. It is understood that the disclosed technology may also be applied to communication between an end-user wireless device and other network resources, depending on the RAT and network technology being implemented. Further, either of core network 110 and RAN 120 can include one or more of a local area network, a wide area network, and an internetwork (including the Internet) capable of communicating signals and carrying data, for example, to support voice, push-to-talk, broadcast video, and data communications by wireless devices. Alternatively, or additionally to the UPF and CPF, the illustrated network topology can include packet gateways, such as a CUPS based user plane S-GW, P-GW, or SAE-GW.

The core network 110 may incorporate many functions not shown in FIG. 1. For example, the CPF may include but are not limited to a Network Slice Selection Function (NSSF), a Network Exposure Function (NEF), a NF Repository Function (NRF), a Policy Control Function (PCF), a Unified Data Management (UDM), an Application Function (AF), a Short Message Service Function (SMSF), a Core Access and Mobility management Function (AMF), a Session Management Function (SMF), and an Authentication Server Function (AUSF). The UPF may also include, for example, a Unified Data Repository (UDR).

The communication network 100 may further include a tracking system 400, which is illustrated as operating between the core network 110 and the RAN 170. However, it should be noted that the tracking system 400 may be distributed. For example, the tracking system 400 may utilize components located at both the core network 110 and at the multiple access nodes 130a, 130b. Alternatively, the tracking system 400 may be an entirely discrete system operating within the core network 110 or between the core network 110 and the RAN 120 or within the RAN 120.

The tracking system 400 receiving location coordinates for wireless gateway devices 200. For example, the tracking system 400 may receive location coordinates over time. Further, information pertaining to access node technology may also be transmitted. In embodiments set forth herein, the wireless gateway device 200 may send location coordinates to the access nodes 130a and 130b, which conveys location coordinates to the tracking system 400.

The tracking system 400 analyzes this information in accordance with a stored model in order to create and store location coordinates in a wireless gateway device profile. In embodiments set forth herein, the wireless gateway device profile may represent location of a single wireless gateway device 200 over time. Further, the tracking system 400 may operate to adjust the attachment of a wireless gateway device 200 and to determine the most used and most recent location of a wireless gateway device 200. Based on this determination, the tracking system 400 may adjust the attachment of a wireless gateway device to the network. Logic is used to determine change in occupancy data (such as multiple listing service (MLS) sales data) and telemetry data over time from wireless gateway devices to identify and categorize subscribers who are moving the wireless gateway device every day, moved to a different fixed location in the past and/or have moved to a fixed location recently.

In implementation, fixed locations from subscriber profiles for wireless gateway devices are determined. The fixed locations are compared to change in occupancy data (such as MLS sales data) to determine if a fixed location has changed occupants. The location coordinates for the wireless gateway devices are collected. The location coordinates for the wireless gateway device may include the most used location and most recent location from the RF telemetry data.

A combined data set using Mobile Station International Subscriber Directory Number (MSISDN) and International Mobile Equipment Identity (IMEI) is created. Using data from the combined data set, in embodiments, the distance from a fixed location and the most used location (based on the location coordinates) is determined for the wireless gateway device. The distance from a fixed location and the latest used location (based on the location coordinates) is determined for the wireless gateway device. The fixed location may be original location for the subscriber contact. In embodiments, the fixed location may be identified as having a change in occupancy (e.g., residence has been sold).

For example, in FIG. 1, wireless gateway device 200 may stay in a fixed location or be moved. In the example, the fixed location 140a is the residence location for the wireless gateway device. There is a threshold distance 150 (or geofencing) from fixed location 140a. When the wireless gateway device 200 moves from fixed location 140a, it is determined whether the distance of the move satisfies a threshold distance 150.

Based on the distances calculated and threshold distance 150, wireless gateway device 200 may be categorized. For example, if the most used location is 140b and is greater than a threshold distance from fixed location 140a and wireless gateway device 200 uses a threshold number of different access nodes on a regular basis (e.g., daily), the wireless gateway device is categorized as “moves every day.”

If the distance of most used and latest used locations are within a threshold distance 150 from the fixed location 140a, the wireless gateway device is categorized as “used where it was sold.”

If the distance of the most used location 140c and the latest used location 140c are greater than a threshold distance 150 from the fixed location 140a, the wireless gateway device is categorized as “used not at sold location.” Additional categories include “recently moved” if the most used location is near the fixed location and “most of the use is not where sold” if the latest location is near sold location but is not the most used location.

The capability of the wireless gateway device may be adjusted based on the category determined for the wireless gateway device. For example, if the wireless gateway device satisfies a threshold distance from fixed location 140a, (e.g., is outside the geofencing coordinates for the fixed location 140a) the capability of the wireless gateway device to attach to a wireless network is adjusted. Adjusting the capability of the wireless gateway device to attach to the wireless network may include preventing the wireless gateway device 200 from attaching to the wireless network. For example, if the wireless gateway device 200 is categorized as “moves everyday” the wireless gateway device 200 may be prevented from attaching to the wireless network as the intended purpose is to be used from a fixed location and not to be used as a Wi-Fi hot spot. Adjusting the capability of the wireless gateway device 200 to attach to the wireless network may include changing the fixed location 140a to a new fixed location 140c for the wireless gateway device 200. Adjusting the capability of the wireless gateway device 200 to attach to the wireless network may include changing a wireless network subscription for the wireless gateway device. For example, the subscriber may pay an additional fee to be able to move the wireless gateway device 200 from a fixed location 140a and use at one or more locations such as location 140b.

The wireless gateway device 200 may be or include a router or router/modem combination that deploys a wireless local area network (WLAN) providing Internet access via Wi-Fi to wireless devices.

Other network elements may be present to facilitate communication but are omitted for clarity, such as base stations, base station controllers, mobile switching centers, dispatch application processors, and location registers such as a home location register or visitor location register. Components not specifically shown in FIG. 1 can further include processing nodes, controller nodes, routers, gateways, and physical and/or wireless data links for communicating signals among various network elements, additional base stations, controller nodes, telephony switches, internet routers, network gateways, computer systems, communication links, or other type of communication equipment, and combinations thereof.

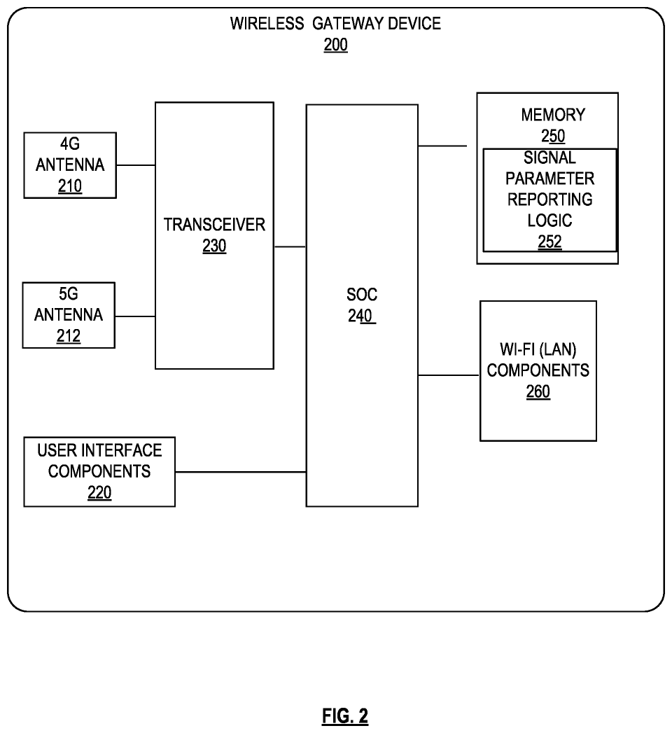

FIG. 2 illustrates a wireless gateway device 200 in accordance with embodiments described herein. The components described herein are merely exemplary as many different configurations for the wireless gateway device 200 may be implemented. The wireless gateway device 200 may include, for example, multiple antennas for communicating with a cellular network such as antenna 210 and antenna 212. Different antennas may connect with different RATs. For example, antenna 210 may connect with a 4G RAT and antenna 212 may communicate with a 5G RAT. The wireless gateway device 200 may further include a transceiver 230, a system on chip (SoC) 240, a memory 250, and Wi-Fi or LAN components 260. Other components may also be included.

The user interface components 220 may operate to allow set-up of the wireless gateway device 200 directly from the wireless gateway device 200. Alternatively, wireless gateway device 200 may be configured to interact with a wireless device, for example using a mobile app, for setup purposes.

The SoC 240 is an integrated circuit that integrates most or all components of a computer or other electronic system. The SoC 240 includes a central processing unit (CPU), memory interfaces, on-chip input/output devices, input/output interfaces, and secondary storage interfaces. Other components, such as a radio modem and radio frequency signal processing may also be included.

The SoC 240 integrates a microcontroller, microprocessor or perhaps several processor cores with peripherals like a GPU, Wi-Fi and cellular network radio modems, and/or one or more coprocessors. The components of the SoC 240 cause the wireless gateway device 200 to function as a both a router and a modem in order to ensure wireless devices access to the Internet through a WLAN. The Wi-Fi or LAN components 260 may include additional antennas, transceivers, and other components to provide the WLAN. In additional embodiments ethernet technologies are incorporated in the wireless gateway device 200 to add to its functionality.

The memory 250 may be or include a random access memory (RAM), read only memory (ROM), disk drive, a flash drive, a memory, or other storage device configured to store data and/or computer readable instructions or codes (e.g., software). The memory 250 may store logic.

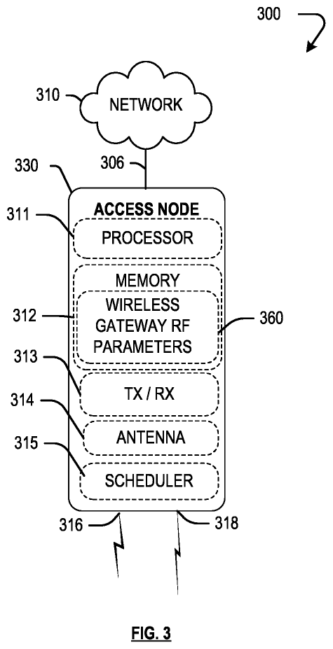

FIG. 3 illustrates an operating environment 300 for an exemplary access node 330 in accordance with the disclosed embodiments. In exemplary embodiments, access node 330 can include, for example, a gNodeB or an eNodeB. Access node 330 may comprise, for example, a macro-cell access node, such as access nodes 130a and 130b described with reference to FIG. 1. Access node 330 is illustrated as comprising a processor 311, memory 312, transceiver(s) 313, and antenna(s) 314, and scheduler 315. Processor 311 executes instructions stored on memory 312, while transceiver(s) 313 and antenna(s) 314 enable wireless communication with other network nodes, such as wireless devices and wireless gateway devices described herein, and other nodes. For example, wireless devices and wireless gateway devices 200 may initiate uplink transmissions such that the transceivers 313 and antennas 314 receive messages from the wireless devices, for example, over communication links 316 and 318 and pass the messages to a mobility entity in the core network. Further, the transceivers 313 and antennas 314 receive signals from the mobility entity such as a mobility management entity (MME) or access and mobility function (AMF) and pass the messages to the appropriate wireless device. Scheduler 315 may be provided for scheduling resources based on the presence and performance parameters of the wireless devices. The access node 330 may connect over a communication link 306 to a network 310. Network 310 may be similar to core network 110 discussed above.

In embodiments provided herein, the memory 312 may further store wireless gateway RF parameters 360. Thus, a processor from the tracking system 400 may communicate with the access node 330 in order to receive relevant RF parameters for the wireless gateway devices 200.

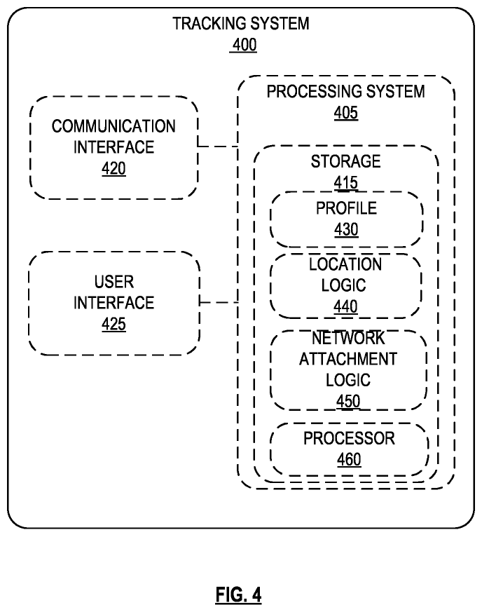

FIG. 4 depicts an exemplary tracking system 400 in communication with wireless gateway devices 200 in accordance with embodiments set forth herein. The tracking system 400 may be configured to perform the methods and operations disclosed herein to receive relevant RF telemetry location coordinates and other data from the wireless gateway device 200 to create a wireless gateway device profile and adjust the attachment of the wireless gateway device 200 to the wireless network. In the disclosed embodiments, the tracking system 400 may be integrated with the core network 110 or may be an entirely separate component capable of communicating with at least the wireless gateway devices 200 and the RAN 120.

The tracking system 400 may be configured for collecting location coordinates transmitted by the wireless gateway device 200 at frequent intervals. Further, the tracking system 400 may determine whether the wireless gateway device 200 has moved from a fixed location based on transmission of RF location coordinates from the wireless gateway device 200.

To track the location of a wireless gateway device 200 and make network attachment adjustments, the tracking system 400 may utilize a processing system 405. Processing system 405 may include a processor 410 and a storage device 415. Storage device 415 may include a RAM, ROM, disk drive, a flash drive, a memory, or other storage device configured to store data and/or computer readable instructions or codes (e.g., software). The computer executable instructions or codes may be accessed and executed by processor 405 to perform various methods disclosed herein. Software stored in storage device 415 may include computer programs, firmware, or other form of machine-readable instructions, including an operating system, utilities, drivers, network interfaces, applications, or other type of software. For example, software stored in storage device 415 may include a module for performing various operations described herein.

Further, the tracking system 400 may store profiles 430 of the wireless gateway devices. The profiles may include historical location coordinates and related access node information. The profiles include location coordinates and access node information over time.

As illustrated, a profile 430 may include location coordinates and network access information. Additional or alternative parameters may also be included. Profiles 430 can be stored and can be further accessed when implementing location logic 440 and network attachment logic 450, which may be executed by the processor 460.

For example, location logic 440 may store instructions to collect and utilize location coordinates from the wireless gateway device 200 over time to determine a wireless gateway device satisfies a threshold distance from a fixed location (e.g., is outside geofencing coordinates) associated with the wireless gateway device. The fixed location may be a known subscriber physical address of the wireless gateway device. The fixed location for the wireless gateway device may be maintained in a wireless gateway device profile.

Location logic 440 collects location coordinates from a wireless gateway device. Location coordinates may include GPS, antenna patterns, communication patterns, Bluetooth, Wi-Fi, and combinations thereof to determine the location of wireless gateway device.

GPS utilizes satellite location and triangulation to determine the coordinates of the UE. A GPS receiver of the UE listens for satellite signals. Once the signals are acquired, the GPS receiver calculates its distance from multiple GPS satellites to determine the location of a wireless gateway device The use of GPS herein is merely an example, and in other implementations the satellite signals may operate on another network such as Galileo, BDS, QZSS, and the like.

Location of a wireless gateway device may also be determined based on Wi-Fi location, measuring power levels and antenna patterns of the wireless gateway device communicating wirelessly with one of the closest terrestrial base stations to determine location of wireless gateway device.

A distance threshold or geofencing coordinates is a collection of data stored that marks virtual geographic boundaries from a fixed location. The geographic boundaries designate areas where wireless gateway device should be operating based on wireless gateway device profile and fixed location. The geographic boundaries are virtual boundaries encompassing certain locations.

Location logic 440 determines a wireless gateway device satisfies a threshold distance from a fixed location (e.g., is outside geofencing coordinates) associated with the wireless gateway device.

Location logic is used to determine change in occupancy data (such as multiple listing service (MLS) sales data) and telemetry data over time from wireless gateway devices to identify and categorize subscribers who are moving the wireless gateway device every day, moved to a different fixed location in the past and/or have moved to a fixed location recently.

In implementation, fixed locations from subscriber profiles for wireless gateway devices are determined. The fixed locations are compared to change in occupancy data (such as MLS sales data) to determine if a fixed location has changed occupants. The location coordinates for the wireless gateway devices are collected. The location coordinates for the wireless gateway device may include the most used location and most recent location from the RF telemetry data.

Location logic determines the distance from a fixed location and the most used location (based on the location coordinates) is determined for the wireless gateway device. The distance from a fixed location and the latest used location (based on the location coordinates) is determined for the wireless gateway device. The fixed location may be original location for the subscriber contact. In embodiments, the fixed location may be identified as having a change in occupancy (e.g., residence has been sold).

Based on the distances calculated, wireless gateway devices may be categorized. For example, if the distance of the most used location is greater than a threshold distance from the fixed location and wireless gateway device uses a threshold number of different access nodes on a regular basis (e.g., daily), the wireless gateway device is categorized as “moves every day.”

If the distance of most used and latest used locations are within a threshold distance from the fixed location, the wireless gateway device is categorized as “used where it was sold.”

If the distance of the most used location and the latest used location are greater than a threshold distance from the fixed location, the wireless gateway device is categorized as “used not at sold location.” Additional categories include “recently moved” if the most used location is near the fixed location and “most of the use is not where sold” if the latest location is near sold location but is not the most used location.

The network attachment logic 450 adjusts the capability of the wireless gateway device to attach to the network based on the category determined for the wireless gateway device. For example, if the wireless gateway device satisfies a threshold distance from fixed location (e.g., is outside the geofencing coordinates for the fixed location) the capability of the wireless gateway device to attach to a wireless network is adjusted. Adjusting the capability of the wireless gateway device to attach to the wireless network may include preventing the wireless gateway device from attaching to the wireless network. For example, if the wireless gateway device is categorized as “moves everyday” the wireless gateway device may be prevented from attaching to the wireless network as the intended purpose is to be used from a fixed location and not to be used as a Wi-Fi hot spot. Adjusting the capability of the wireless gateway device to attach to the wireless network may include changing the fixed location to a new fixed location for the wireless gateway device. Adjusting the capability of the wireless gateway device to attach to the wireless network may include changing a wireless network subscription for the wireless gateway device. For example, the subscriber may pay an additional fee to be able to move the wireless gateway device from a fixed location and use at one or more other locations.

Processor 460 may be a microprocessor and may include hardware circuitry and/or embedded codes configured to retrieve and execute software stored in storage device 415.

The tracking system 400 further includes a communication interface 420 and a user interface 425. Communication interface 420 may be configured to enable the processing system 405 to communicate with other components, nodes, or devices in the wireless network. For example, the tracking system 400 receives relevant parameters from an access node 330 or from the wireless gateway devices 200.

Communication interface 420 may include hardware components, such as network communication ports, devices, routers, wires, antenna, transceivers, etc. User interface 425 may be configured to allow a user to provide input to the tracking system 400 and receive data or information from access node 330 or the wireless gateway devices 200. User interface 425 may include hardware components, such as touch screens, buttons, displays, speakers, etc. The tracking system 400 may further include other components such as a power management unit, a control interface unit, etc.

The location of the tracking system 400 may depend upon the network architecture. As set forth above, the tracking system 400 may be located in the core network 110, in a separate processing node, may be an entirely discrete component, or may be distributed. Further, although shown as a single integrated system. For example, the functions of throughput estimation and troubleshooting may be separated and disposed in separate locations.

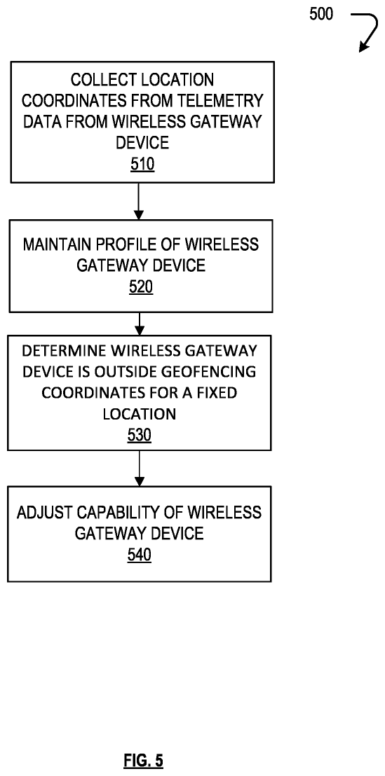

The disclosed methods for adjusting wireless gateway device access to a wireless network are further described below with reference to FIG. 5. FIG. 5 illustrates an exemplary method 500 performed by a tracking system 400. Method 500 may be performed by any suitable processor discussed herein, for example, the processor 460 included in the tracking system 400 or any other suitable processor. For the sake of convenience, the method is described as being performed by the processor 460.

Method 500 starts in step 510, when the processor 460 collects location coordinates from the wireless gateway device 200. For example, the wireless gateway device 200 transmits telemetry data and information with location coordinates and information about access nodes used on a regular basis. The wireless gateway device 200 may also transmit the access technology, band, and bandwidth.

Based on the data collected in step 510, the processor 460 builds and maintains wireless device profiles in step 520 as explained above. Thus, the profile includes the location coordinates for the wireless gateway device as well as related time of collection.

Subsequently, in step 530, processor 460 applies the location logic above to the location coordinates of the wireless gateway devices 200. At step 530 it is determined whether the location coordinates of the wireless gateway device satisfy a threshold distance (e.g., are outside geofencing coordinates) for a fixed location. Wireless gateway devices are categorized based on whether the wireless gateway device satisfies the threshold distance.

Finally, in step 540, the processor 460 adjusts the capability of a wireless gateway device to attach to a wireless network based on the category of device. For example, if the wireless gateway device satisfies a threshold distance from fixed location (e.g., is outside the geofencing coordinates for the fixed location) the capability of the wireless gateway device to attach to a wireless network is adjusted. Adjusting the capability of the wireless gateway device to attach to the wireless network may include preventing the wireless gateway device from attaching to the wireless network. For example, if the wireless gateway device is categorized as “moves everyday” the wireless gateway device may be prevented from attaching to the wireless network as the intended purpose is to be used from a fixed location and not to be used as a Wi-Fi hot spot. Adjusting the capability of the wireless gateway device to attach to the wireless network may include changing the fixed location to a new fixed location for the wireless gateway device. Adjusting the capability of the wireless gateway device to attach to the wireless network may include changing a wireless network subscription for the wireless gateway device. For example, the subscriber may pay an additional fee to be able to move the wireless gateway device from a fixed location and use at one or more other locations.

In some embodiments, method 500 may include additional steps or operations. As one of ordinary skill in the art would understand, the method 500 may be integrated in any useful manner.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication network 100 may be, comprise, or include computers systems and/or processing nodes, including access nodes, controller nodes, and gateway nodes described herein.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A system configured for adjusting attachment of a wireless gateway device, the system comprising:
one or more hardware processors configured by machine-readable instructions to:
collect location coordinates for radio frequency telemetry data from a wireless gateway device;
determine from the location coordinates the wireless gateway device is outside geofencing coordinates for a fixed location associated with the wireless gateway device; and
based on determining from the location coordinates the wireless gateway device is outside the geofencing coordinates for the fixed location, adjust a capability of the wireless gateway device to attach to a wireless network.

2. The system of claim 1, wherein the one or more hardware processors are further configured by machine-readable instructions to determine a change in occupant for the fixed location.

3. The system of claim 2, wherein adjusting the capability of the wireless gateway device to attach to the wireless network comprises preventing the wireless gateway device from attaching to the wireless network.

4. The system of claim 2, wherein adjusting the capability of the wireless gateway device to attach to the wireless network comprises changing the fixed location to a new fixed location for the wireless gateway device.

5. The system of claim 2, wherein adjusting the capability of the wireless gateway device to attach to the wireless network comprises changing a wireless network subscription for the wireless gateway device.

6. The system of claim 1, wherein the fixed location is a known subscriber physical address of the wireless gateway device.

7. The system of claim 6, wherein the fixed location for the wireless gateway device is maintained in a wireless gateway device profile.

8. A method for adjusting attachment of a wireless gateway device, the method comprising:
collecting location coordinates for radio frequency telemetry data from a wireless gateway device;
determining from the location coordinates the wireless gateway device satisfies a distance threshold for a fixed location associated with the wireless gateway device; and
based on determining from the location coordinates the wireless gateway device satisfies a distance threshold from the fixed location, adjusting a capability of the wireless gateway device to attach to a wireless network.

9. The method of claim 8, further comprising determining a change in occupant for the fixed location.

10. The method of claim 9, wherein adjusting the capability of the wireless gateway device to attach to the wireless network comprises preventing the wireless gateway device from attaching to the wireless network.

11. The method of claim 9, wherein adjusting the capability of the wireless gateway device to attach to the wireless network comprises changing the fixed location to a new fixed location for the wireless gateway device.

12. The method of claim 9, wherein adjusting the capability of the wireless gateway device to attach to the wireless network comprises changing a wireless network subscription for the wireless gateway device.

13. The method of claim 8, wherein the fixed location is a known subscriber physical address of the wireless gateway device.

14. The method of claim 13, wherein the fixed location for the wireless gateway device is maintained in a wireless gateway device profile.

15. A non-transient computer-readable storage medium having instructions embodied thereon, the instructions being executable by one or more processors to perform a method for adjusting attachment of a wireless gateway device, the method comprising:
collecting location coordinates for radio frequency telemetry data from a wireless gateway device;
determining from the location coordinates the wireless gateway device is outside geofencing coordinates for a fixed location associated with the wireless gateway device; and
based on determining from the location coordinates the wireless gateway device is outside the geofencing coordinates for the fixed location, adjusting a capability of the wireless gateway device to attach to a wireless network.

16. The computer-readable storage medium of claim 15, wherein the method further comprises determining a change in occupant for the fixed location.

17. The computer-readable storage medium of claim 16, wherein adjusting the capability of the wireless gateway device to attach to the wireless network comprises preventing the wireless gateway device from attaching to the wireless network.

18. The computer-readable storage medium of claim 16, wherein adjusting the capability of the wireless gateway device to attach to the wireless network comprises changing the fixed location to a new fixed location for the wireless gateway device.

19. The computer-readable storage medium of claim 16, wherein adjusting the capability of the wireless gateway device to attach to the wireless network comprises changing a wireless network subscription for the wireless gateway device.

20. The computer-readable storage medium of claim 15, wherein the fixed location is a known subscriber physical address of the wireless gateway device.
